(19) United States
(12) Patent Application Publication
(10) Pub. No.: US 2010/0199197 A1
(43) Pub. Date: Aug. 5, 2010

(54) SELECTIVE CONTENT TRANSCODING

(75) Inventors: Igor Faletski, Vancouver (CA); John Boxall, Vancouver (CA); Kevin Tom, San Francisco, CA (US); Matthew Snyder, Vancouver (CA); Peter McLachlan, Vancouver (CA)

Correspondence Address: BOSWELL IP Law, 601 Union Street, SUITE 4200, SEATTLE, WA, 98101-4036, US

(73) Assignee: HANDI MOBILITY INC, Vancouver (CA)

(21) Appl. No.: 12/626,914

(22) Filed: Nov. 29, 2009

Related U.S. Application Data
(60) Provisional application No. 61/118,598, filed on Nov. 29, 2008.

(51) Int. Cl. G06F 3/048

(52) U.S. Cl. 715/760; 715/810; 715/771

(57) ABSTRACT

A selective transcoding system makes creating mobile versions of websites more automated with results closer to the look and feel of the original website and modified to account for mobile access patterns. The system gives control over the transcoding process to the content author with the result typically accessible through a standard URL. Selective transcoding employs a layer of customizable transcoding proxy servers between the source website and mobile users for improving the presentation of existing web content. Content authors can perform customization of the proxy through controls at selective transcoding web portal. When a mobile user visits the selective transcoding proxy, the user sees the blocks selected by the web designer updated with newest content and transcoded for the user's mobile device. Thus, the selective transcoding system provides a better mobile experience.

### CROSS-REFERENCE TO RELATED APPLICATIONS

The present application claims priority to U.S. Provisional Patent Application No. 61/118,598 (Attorney Docket No. HANDIMOB001) entitled “SELECTIVE CREATION, OPTIMIZATION, AND TRANSCODING OF WEBSITES, SUCH AS FOR MOBILE ACCESS,” and filed on Nov. 29, 2008, which is hereby incorporated by reference.

### BACKGROUND

Mobile access to the Web is becoming more commonplace every day (for instance, in November 2008 Bango reported that up to 5% of all web visits are from mobile devices). Advanced device families, such as the Apple iPhone, S60, and Google Android include browsers with full Extensible Hypertext Markup Language (XHTML)/Cascading Style Sheet (CSS)/JavaScript capacity that can render the same sites as their desktop counterparts. This experience has been made possible by rapid growth of mobile broadband powered by 3G and Wi-Fi chips, faster hardware, and the resulting migration of mature technologies like Linux, Web Kit, and Mac OS X to handheld devices. While these advanced devices are selling by millions every quarter, there are hundreds of millions of internet-enabled mobile devices already in customers' pockets with fewer capabilities. Each of these devices can have different browsers, screen sizes, and hardware features.

Content consumption patterns of users of mobile devices often differ significantly from those of desktop users. For example, while a mobile device can render a regular website in its default resolution (typically 1024×768), the device's physical screen size may be restricted to several inches, with effective resolution of most screens being anywhere from 128×128 pixels to 320×480 pixels. The approach currently employed by mobile browser designers involves complex scrolling and zooming functionality enabled by a keyboard, a multi-touch screen, or a trackball. This type of navigation may not provide a satisfying user experience.

Attention span and focus of mobile users is also quite different from that of desktop users. “Bite-sized” content, which is customized to user context and locale, is preferred to the “portal” approach where excessive amounts of links and information are presented from which the user can select. Delivering a full website in its original shape to a mobile device does not optimize for the mobile context. In particular, the author of the web site usually has very little control over the web site's mobile presentation, unless considerable engineering efforts are invested in developing a standalone mobile site.

One problem that is not addressed by the core technology of the web is optimizing source content for capabilities of a particular device with the device's specific constraints. Several solutions have emerged that deliver inconsistent results. For example, automatic transcoding involves transcoding (e.g., creating a version for mobile display) every page of a web site through an automated proxy. Typically, automated transcoding strips out JavaScript, resizes images for the mobile form factor, and adjusts font sizes. Each uniform resource locator (URL) request from the original page also returns a transcoded version. Automatic transcoding achieves a good level of compression for the resulting pages, but often results in severe distortion to a site's navigational structure and look/feel that can be disconcerting for users.

Another example is Really Simple Syndication (RSS) conversion, which relies on web RSS/atom feeds as sources of content for a web site. A webmaster is prompted to select a feed or have it automatically discovered after entering a URL of his website. The content of the RSS feed is then available for basic styling and layout control on a mobile version of the site. RSS conversion provides a base level of functionality and content for any created mobile website. Many existing sites do not have RSS feeds, yet might feature interactive components like forms. This leads to RSS conversion being most applicable for websites built around a stream of text content (e.g., blogs) without extensive interaction with the user (such as comments and preferences). Mobile versions created with RSS conversion bear little relation to the look and feel of the original website.

A further example (and the most expensive) is that used by some of the biggest websites, which build out custom mobile versions of web sites specifically for mobile access—complete with distinct frameworks, custom stylesheets, and content management systems (CMS). This custom mobile design approach produces sites that are of high quality and considerably expensive. The major problem of supporting such sites is the separation of content management flows that often occurs between the desktop and mobile versions. Unless there is a uniform CMS solution implemented, the content authors may be asked to maintain and enter data for two distinct versions of their web portals (mobile and desktop).

Another problem is that wireless spectrum used by cellular technology (e.g., bandwidth) is limited and facing congestion as the number of users of unlimited data plans increase. Due to differences in content consumption patterns described herein, a large part of content downloaded for displaying a web site may not be relevant to the user and therefore go unutilized. This is already a problem in highly populated urban areas with many data-enabled devices.

### BRIEF DESCRIPTION OF THE DRAWINGS

FIG. 1 is a block diagram that illustrates components of the selective transcoding system, in one embodiment.

FIG. 2 is a flow diagram that illustrates processing of the selective transcoding system to transcodes a content page, in one embodiment.

FIG. 3 is a flow diagram that illustrates processing of the system to respond to a request for a mobile version of a content page, in one embodiment.

FIG. 4 is a display diagram that illustrates a user interface of the selective transcoding system for selecting content to include in a mobile view, in one embodiment.

FIG. 5 is a display diagram that illustrates a user interface of the selective transcoding system for a control panel, in one embodiment.

FIG. 6 is a display diagram that illustrates two mobile devices displaying a normal and mobile view of a web page, in one embodiment.

### DETAILED DESCRIPTION

A selective transcoding system is described herein that makes creating mobile versions of websites more automated with results closer to the look and feel of the original website and modified to account for mobile access patterns. The system gives control over the transcoding process to the content author with the result typically accessible through a standard URL. Selective transcoding employs a layer of customizable transcoding proxy servers between the source website and mobile users for improving the presentation of existing web content. Content authors can perform customization of the proxy through controls at selective transcoding web portal. In some embodiments, the content author begins by entering a URL of a web page. For example, the content author may select the home page of a site that the content author wants to prepare for mobile device rendering. The selective transcoding system displays the web page to the content author as a series of potentially relevant blocks of content. For example, the system may display a menu navigation block, a main text block, and so forth. The system receives a selection of relevant blocks from the content author using a simple point-and-click interface for each web page. For example, the content author may select the main text block of the website to change formatting for that block.

The system records the selections of the content author and allows the content author to selectively adapt the author's existing CSS stylesheets for mobile devices with live previews of the results. For example, the author may change a default font associated with the selected content. When the content author is finished, the selective transuding system receives a selection of one or more deployment options for the mobile version of the web page. For example, the deployment options may include creating a separate URL for accessing mobile content, an automatically generated native application for a particular platform, or a JavaScript redirect code snippet placed into existing code of the original web page. When a mobile user visits the selective transcoding proxy (which sits behind the original URL through one of the redirection options available), the user sees the blocks selected by the webmaster updated with newest content and transcoded for the user's mobile device. Thus, the selective transcoding system provides a better mobile experience in a way that: 1) is easily performed by a webmaster from within a browser by pointing-and-selecting elements of an existing website, and 2) provides a resulting site hosted at a URL and not forced upon the end-user through automatic transcoding or mobile browsers.

There are radical differences between selective transcoding and automatic transcoding when it comes to selection of content. For example, automatic transcoding does not allow for any input from the content author or end user about what content appears on a mobile device and how the content looks. Rather, all of decisions with automatic transcoding are made by the transcoding server with no human interaction. This often leads to major flaws in design of the generated page without a path for fixing the flaws. In contrast, the selective transcoding system provides the content author with options for indicating which content will be displayed on mobile devices and how that content will look. The problem of properly representing web content on a mobile device is closely related to presenting the most useful content, styled properly. Selective transcoding provides the content author with creative control—both in regards to selecting the content blocks and the styling that is pre-populated and modifiable. This produces a mobile site with less traffic generated (e.g., due to dropping rich content and advertising unsuitable for mobile devices) and a look and feel closely matching that of the original site.

Selective transcoding also provides different results than RSS conversion and custom mobile design. The selective transcoding system provides significantly more freedom to the content author in terms of the content that is presented to a mobile user, which is reflected in higher customer satisfaction. The system provides a selection mechanism that builds a true “mobile view” of a website, rather than having just a simple data source mobilized. A major advantage of selective transcoding over custom mobile design is lower cost. The selective transcoding system allows creating persistent mobile views of a site within several minutes and maintaining them easily over time. There is no separate workflow involved in maintaining a selectively transcoded mobile site, as the content is taken from the source desktop site directly. Only selective transcoding provides a point-and-click workflow for creating a mobile view of a website accessible to anyone through a web browser.

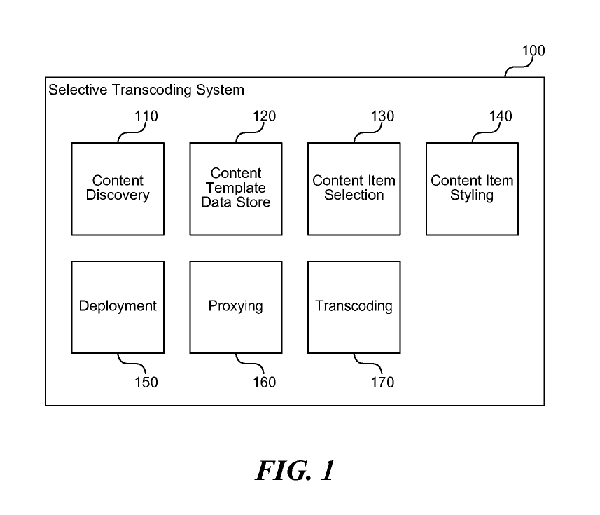

FIG. 1 is a block diagram that illustrates components of the selective transcoding system, in one embodiment. The system 100 includes a content discovery component 110, a content template data store 120, a content item selection component 130, a content item styling component 140, a deployment component 150, a proxying component 160, and a transcoding component 170. Each of these components is described in further detail herein.

The content discovery component 110 identifies content pages associated with a content repository. For example, the component 110 may prompt a user to input a URL of a content page that the user wants to prepare for mobile consumption. Alternatively or additionally, the component 110 may automatically crawl a website (e.g., with a crawler that performs a deep scan of a content site's internal link structure and generates potential content pages using regular expressions or other analysis) or examine a log of previous accesses of the repository to determine the content pages associated with the repository. The content author can also provide template URLs directly should the automatic scan not detect some content pages. In some embodiments, instead of automated discovery and proxying of new content, the selective transcoding system uses a one-to-one mechanism whereby the content author manually enables each new content page for mobile delivery as the author creates content pages. The content discovery component 110 may create a template to store changes for each discovered content page and store the template in the content template data store 120.

In some embodiments, the discovery mechanism intelligently determines content pages that exist in a website through analyzing URL patterns. In some cases, each template of a web site only has to be mobile-enabled once. As additional content generally follows the same URL patterns and document object model (DOM) conventions (until a major re-design), the selective transcoding system 100 is capable of applying the same set of rules to the source website in its entirety in order to generate mobile pages.

The content template data store 120 stores templates for the identified content pages and any modifications made by a content author for mobile rendering of the content pages. The data store 120 may include a database, local disk drive, storage area network (SAN), cloud-based storage service, or any other method of storing data for later access in response to client requests or further changes from the content author.

The content item selection component 130 displays a user interface to the content author and receives one or more selections of content items associated with identified content pages. The component 130 may automatically identify content items, such as by analyzing hypertext markup language (HTML) tags (e.g., DIV tags that logically divide blocks) and present the content items for selection by the content author. The content author selects content items that the content author wants to include in a mobile version of the content page. The content item selection component 130 provides the content author with a point-and-click user interface into the layout of an existing site.

In some embodiments, after the content author selects content items, the content item selection component 130 constructs XPath expressions to describe the items' positions in the DOM structure of the content page. As the content author places new content on a content page, the system 100 selects the new content using XPath and passes the new content into the mobile version of the content page. The content author may later decide to exclude some content items that were previously included and may further edit the mobile template.

Content authors can select content in many different ways. In some embodiments, instead of a point-and-click interface the selective transcoding system 100 provides a descriptive language, micro-format, or CSS tag to mark the elements of the original site that the system 100 will transcode, as well the elements' resulting order and style. Alternatively or additionally, the system may take screenshots of the source site pages and allow the user to manipulate the screenshots with parts of the site represented through images. This provides improved compatibility with a range of existing websites but the readability of the result can suffer. Those of ordinary skill in the art will recognize various other interfaces for identifying and selecting content items.

The content item styling component 140 generates one or more mobile styles related to one or more original styles associated with a content page. For example, the component 140 may produce a stylesheet that excludes tags that most mobile devices cannot render well. The component 140 may also include controls for adding more styling information either by direct CSS input or What-You-See-Is-What-You-Get (WYSIWIG) controls. In some embodiments, the user receives a list of templates to use for their mobile-enabled site instead of direct CSS controls. The system optimizes the templates for different devices (e.g., there are several settings with different underlying technology, such as absence or presence of Asynchronous JavaScript and XML (AJAX)). This may reduce flexibility but make the process easier to follow.

The system 100 uses the content item styling component 140 to make mobile-enabled content sites appear as close as possible to the original site with little to no content author editing. The component 140 generates a derivative stylesheet targeted to mobile devices. This process keeps platform-neutral information such as font-weight, color, and alignment while removing elements not applicable for most mobile browsers. Then the content author can override any particular style definition through direct CSS editing or WYSIWIG dashboard controls. Hybrid mobile styling provides a look and feel that preserves that of the original site with very little content author effort.

The deployment component 150 receives a deployment indication from the content author and deploys a mobile version of one or more content pages. For example, the content author may request a new URL for accessing the mobile version of a content page, and the component 150 deploys the mobile version to the new URL. Alternatively or additionally, the component 150 may insert JavaScript or other instructions into a content page of the original site to redirect mobile users to a mobile version of the content page.

The proxying component 160 caches mobile-enabled resources pre-rendered for popular mobile devices to enhance performance. In some embodiments, rather than caching and proxying mobile-enabled versions of all of a web site's pages, a content author can select blocks from several pages in order for the system to present them all on one resulting page.

The transcoding component 170 transcodes content resources to automatically produce mobile versions of the resources. Although some elements of content benefit from control of the content author, others are simple enough for the system 100 to automatically provide a mobile version. Frameworks exist, such as Handi's Bloom framework, for modifications such as image resizing and font size scaling based on the User Agent parameter of HTTP requests coming from a mobile device. In some embodiments, the system uses third-party transcoding services like Google for optimizing web pages created using the system 100 rather than an internal transcoder.

The computing device on which the selective transcoding system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

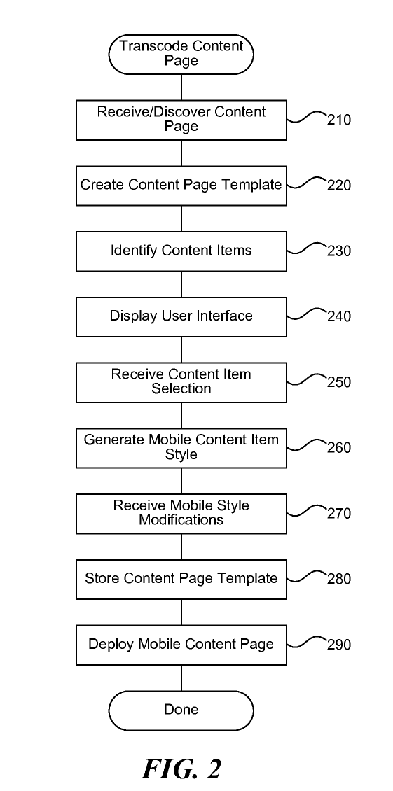

FIG. 2 is a flow diagram that illustrates processing of the selective transcoding system to transcode a content page, in one embodiment. Beginning in block 210, the system receives a content page that a content author selects for transcoding to a mobile version. For example, the system may receive a URL from the content author or may crawl a website identified by the content author to identify content pages associated with the site. Continuing in block 220, the system creates a content page template that tracks selections and modifications to the received content page for rendering a mobile version of the content page. For example, the system may create a default template that includes all of the content from the original content page scaled for one or more mobile devices.

Continuing in block 230, the system identifies content items within the received content page. For example, the system may identify blocks of HTML elements or individual elements that the content author may want to style differently for the mobile version of the content page. Continuing in block 240, the system displays a user interface through which the content author can select one or more of the identified content items. The content author may enable/disable each content item for inclusion in the mobile version of the content page as well as overriding style information for the mobile version of the content page. Continuing in block 250, the system receives a content item selection from the content author that indicates a content item among the identified content items for inclusion in the mobile version of the content page. For example, the content author may click on a displayed rendering of the content item.

Continuing in block 260, the system generates a mobile content item style for the content item selection that provides styling of the selected content item for a mobile device. For example, the system may remove HTML tags that do not display well on the mobile device, or may modify element details, such as font sizes, element widths, alignment (e.g., to convert a two-column display to a single-column display), and so forth. Continuing in block 270, the system receives from the content author one or more modifications to the generated mobile content item style. For example, the content author may override an automatically selected font size or color selected by the system. This gives the content author ultimate control over the appearance of content items in the mobile version of the content page.

Continuing in block 280, the system stores the content page template with any modified and generated mobile content item styles in a data store. For example, the system may store the template in a database. Continuing in block 290, the system deploys the mobile version of the content page so that users of mobile devices can access the mobile version. For example, the system may set up a URL in a web server for receiving requests for the mobile version of the content page. After block 290, these steps conclude.

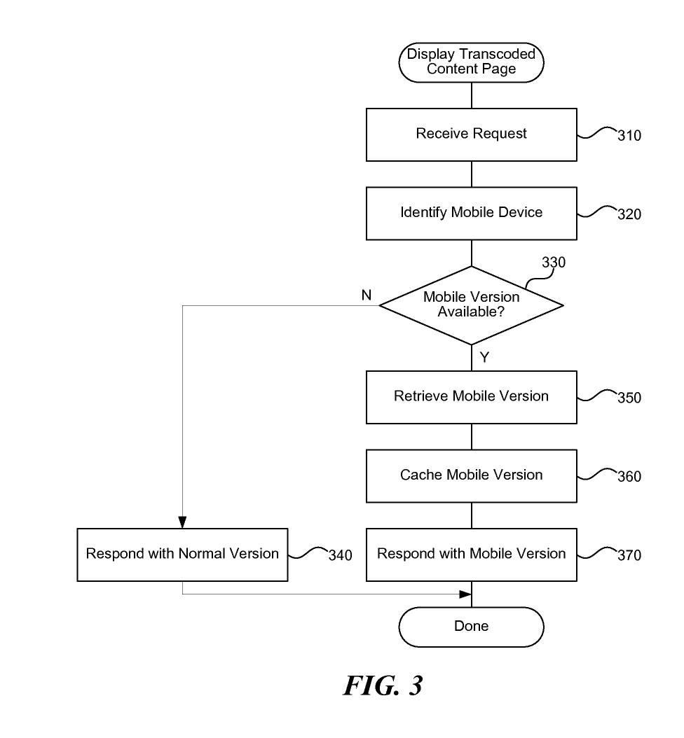

FIG. 3 is a flow diagram that illustrates processing of the system to respond to a request for a mobile version of a content page, in one embodiment. Beginning in block 310, the system receives a request to access an identified content page. For example, the system may receive an HTTP GET request for a URL provided by a web server running the selective transcoding system. The URL may be associated with a mobile version of the identified content page. Continuing in block 320, the system determines a mobile device associated with the received request. For example, the mobile device may provide information in the request, such as an HTTP User-Agent header, that identifies the type or capabilities of the mobile device.

Continuing in decision block 330, the system determines whether a mobile version of the identified content page is available for the determined mobile device. If a mobile version is available, then the system continues at block 350, else the system jumps to block 340. Continuing in block 340, the system responds to the received request with a normal version of the identified content page. This may be appropriate for mobile devices with advanced content display capabilities, or for pages for which no mobile version has been created yet. After block 340, the system completes. Continuing in block 350, the system retrieves the mobile version of the identified content page for the determined mobile device. For example, the system may retrieve an original version of the content page and a modified stylesheet for rendering the content page on the determined mobile device. The stylesheet may include changes such as content layout, element styling, and so forth.

Continuing in block 360, the system optionally caches the retrieved mobile version of the content page. The processing of mobile versions of content pages may be extensive enough to warrant caching of the result once it has been requested once so that subsequent requests can use the cached version without repeating the processing. Continuing in block 370, the system responds to the received request with the retrieved mobile version of the content page. For example, the system may provide a standard HTTP response (e.g., “200 OK”) with the mobile version of the content page as additional data. After block 370, these steps conclude.

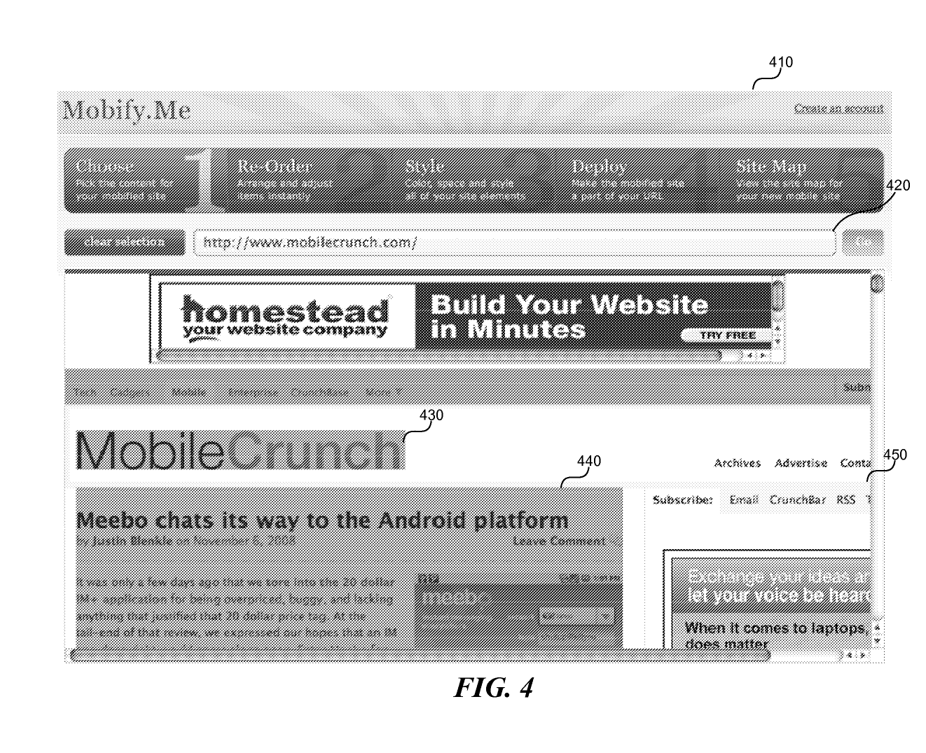

FIG. 4 is a display diagram that illustrates a user interface of the selective transcoding system for selecting content to include in a mobile view, in one embodiment. A display page 410 displays a web page of a site specified in an address bar 420. The web page includes various content items, including a title 430, an article 440, and a menu bar 450. A content author can select the content items to be included in a mobile version of the web page by clicking elements. In this example, the title 430 and article 440 are shown with a highlighted background, indicating that they have been selected. The menu bar 450 is not selected and will not be included in the mobile version. The system produces a mobile version of the website based on the content author's selections.

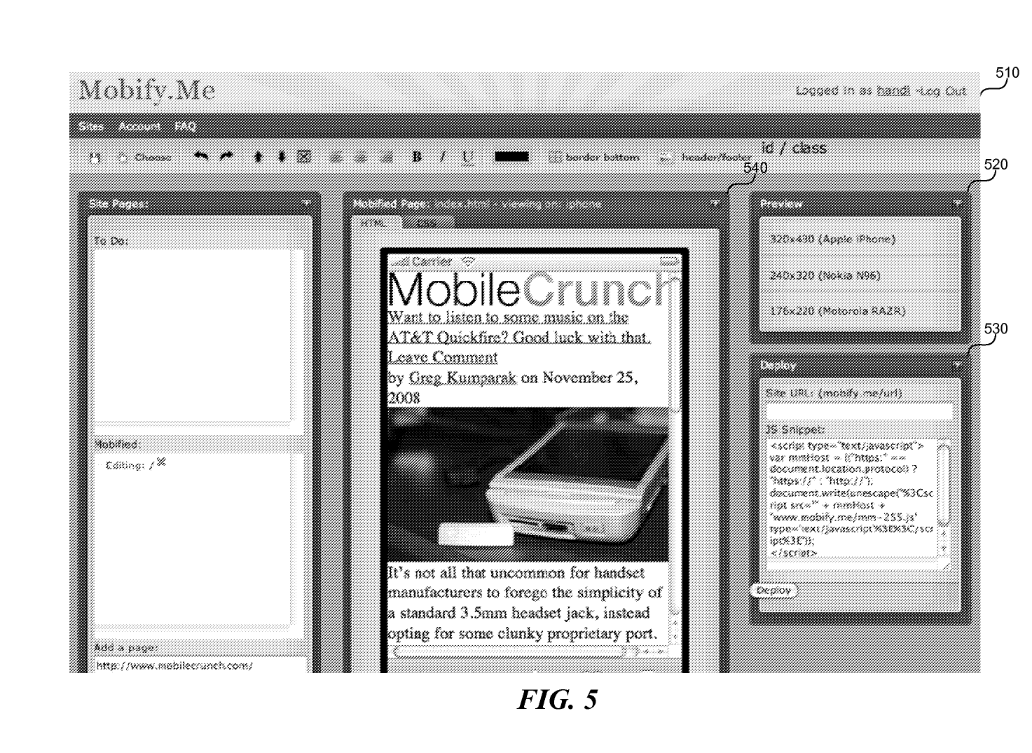

FIG. 5 is a display diagram that illustrates a user interface of the selective transcoding system for a control panel, in one embodiment. The control panel can be delivered as a web page 510 that allows a content author to view and edit the mobile pages of a site that is being edited with the selective transcoding system. The web page 510 includes a preview control 520, a deployment control 530, and a page view area 540. The preview control 520 allows the content author to select various common mobile platforms for which the content author may deploy a content page. For example, the control web page 510 may offer the Apple iPhone as an example mobile platform. The selection of a particular platform has implications in terms of the size of the display of the platform and other features (e.g., availability of a touch screen). The page view area 540 changes based on the selected mobile platform to display a preview of the page on the selected platform. For example, the page view area 540 displays a view based on the selections of FIG. 4 formatted for an Applei Phone screen size. The deployment control 530 provides options for deploying the content page, such as setting a URL for the mobile version of the content page or providing a JavaScript code snippet that the author can insert on an existing non-mobile content page to redirect mobile users to the mobile version.

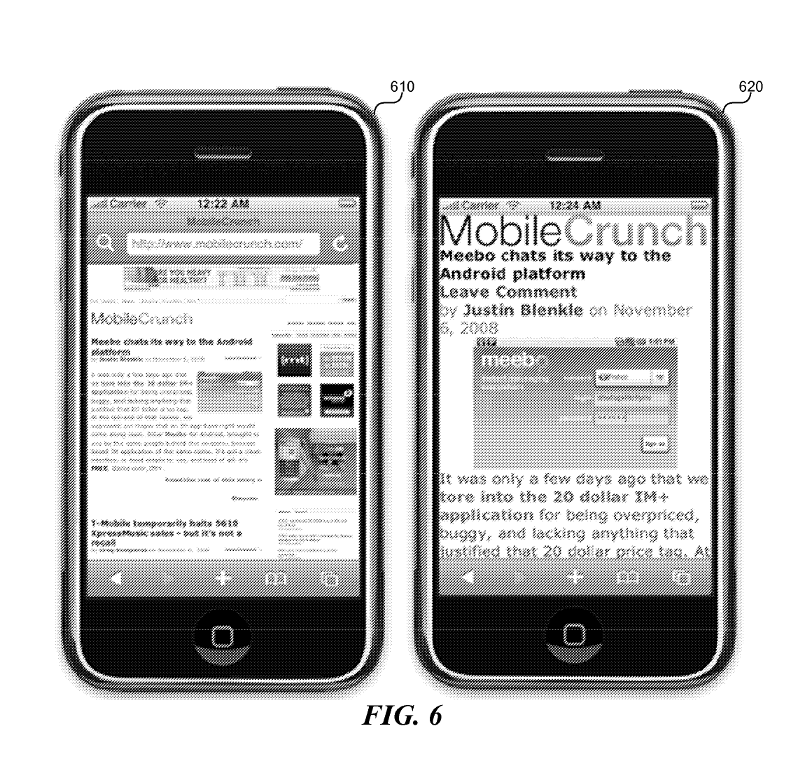

FIG. 6 is a display diagram that illustrates two mobile devices displaying a normal and mobile view of a web page, in one embodiment. The left device 610 is displaying the normal view without changes made by the selective transcoding system. As displayed, the content is cramped and difficult to read without zooming, panning, and scrolling content on the mobile device. The right device 620 displays the content selected in FIG. 4. The content author has excluded content items that are less relevant to a mobile user so that more relevant content items consume more of the display space. This results in a web page that is easier to read without asking the user to zoom or pan as much to see the article.

In some embodiments, the product of transcoding produced by the selective transcoding system is a website accessible at a particular URL location. Unlike previous products that perform automatic transcoding at browser level or at a proxy level, the way of directing end-users to a mobile-enabled site is selected by the content author and is not enforced to be viewed on mobile devices only. For instance, a mobile-enabled site could be hosted at “http://m.mysite.com” or “http://mymobilesite.com” (with a JavaScript redirect) accessible by any device, but optimized for mobile devices.

In some embodiments, the selective transcoding system allows for device-level targeting of generated sites. For instance, while basic optimizations, such as image size and vertical scrolling, are applicable for many mobile devices, some features can be targeted at a specific mobile device (e.g., the Apple iPhone). For example, YouTube Videos and Apple iTunes purchases are supported on the Apple iPhone, but not on older devices. The content author has an opportunity to insert in widgets based on this functionality that the system only provides to users that have target mobile devices.

In some embodiments, the selective transcoding system supports hybrid operations that create the resulting website from a mix of static content (e.g., images, text, and widgets, such as maps and click-to-call numbers) and content proxied from the parent website. For instance, if the content author desires to have the same menu displayed on every page of the mobile-enabled site, the content author would define appropriate static links that the system adds to the proxied content at rendering time for the end-user.

In some embodiments, the selective transcoding system employs link masking to transparently serve content on a mobile-enabled URL while staying search engine optimization (SEO)-friendly. Even though the system may operate as a hosted service, the system allows for DNS CNAME pointers to the generated sites. The content author can provide the DNS address they are using (such as “m.mysite.com”) to be inserted in all internal URLs featured on transcoded pages. This ensures that the end-user and search engine bots are presented with a uniform link structure (e.g., “http://mysite.com/link” becomes “http://m.mysite.com/link” when routed through a mobile-enabled service).

In some embodiments, the selective transcoding system provides artificial intelligence (AI) to predictively select content items for a mobile version of a content page to decrease the amount of time it takes to build the mobile version. The AI saves time for the content author by pre-populating content item selection with mobile-friendly blocks like post content, comments, navigation, and logos. The AI works well with existing CMSs, such as Wordpress, Drupal, and Expression Engine-powered systems and greatly reduces the entry barrier for many users. Thanks to improved content selection algorithms, the system also drastically improves template selection logic for common CMS types. For instance, Wordpress blogs have common structures for “article pages,” with several dominating URL patterns and typical layouts. Upon detecting a supported CMS type, the selective transcoding system creates appropriate templates and automatically picks content to provide a good baseline mobile experience even for websites where the user only worked on the mobile homepage.

In some embodiments, the selective transcoding system provides smart recovery. As the system operates with the presentation layer of a website, the system has to deal with ongoing changes to design and layout. The system attempts to maintain stored selections of content items even with ongoing adding and removing of elements such as DIV tags. The system can use methods, such as tracking CSS identifiers, classes, and typical content to follow selected content items as the content page changes.

In some embodiments, the selective transcoding system allows initialization via a remote application-programming interface (API). For instance, a CMS user might install a plug-in that launches a deep inspection of the web site, including link patterns, styles, other plug-ins, and content. After the deep inspection is complete, the plug-in contacts the selective transcoding system and sets up everything for the content author to make design decisions about a mobile version of the web site. This further lowers the entrance barrier for using the system.

In some embodiments, the selective transcoding system relies on a network of servers distributed in various areas of the world to speed up the transcoding process and decrease latency of mobile content delivery. The site owner has an option of deploying the mobile view to a server closest to their audience, improving the experience of mobile users. For example, a site owner in Japan may select a distribution site in Japan to avoid the latency of locating content further away.

### EXAMPLES

Following are two example uses of the selective transcoding system. In the first example, assume that a news site web designer wants to display a simplified version of the news site to all mobile users. This particular version will include only a logo followed by headlines of top news stories with one-sentence summaries. Clicking on a news story will invoke a simplified view of the news page with only the logo and the body text displayed.

In order to do that, the web designer navigates to a portal associated with the system and clicks on the elements he desires to display for both “homepage” and “news story” templates. After the elements are selected, the web designer proceeds to styling the mobile page. The base CSS style sheet is a mobile-optimized derivative of the full style sheet, so the mobile site looks quite similar to the full one. Then, the web designer picks a deployment option—a choice between the provided third-level domain like “http://site.mobify.me,” DNS redirect for an existing URL (e.g., “http://m.site.com” would point to “http://site.mobify.me”), an automatically generated native application for a particular platform, or a JavaScript redirect redirecting mobile devices to the mobile-optimized site from an existing URL.

In the second example, a site visitor is unaware that the site they are visiting is mobile-enabled. The user begins by entering a URL of the website he wants to view (the selective transcoding system allows for using an existing URL or a separate one) and receives a mobile-optimized version of the page. Any pages he navigates to are transcoded—automatically in case of external links and unrecognized internal links, and properly for mobile-enabled internal links.

### CONCLUSION

The problem of accessing web sites from mobile devices has four parts—mobile context constraints, device fragmentation, content selection, and spectrum scarcity. Regarding mobile context constraints, the selective transcoding system provides an effective means for helping the end user consume content on mobile devices. For example, the selective transcoding system can eliminate horizontal scrolling by providing content as a vertical page adjusted by screen width, which has been shown to provide a satisfying mobile reading experience (e.g., no zooming/panning). The selective transcoding system provides tools and presets for the content author to adjust the transcoded site to mobile conditions (e.g., various light conditions, improved readability) through adjusting, for example, colors and sizes of page elements.

Regarding device fragmentation, the selective transcoding system optimizes source content for any mobile device that navigates to the page. The system selects the baseline XHTML template to match a particular mobile device used to access the webpage. This provides improved view port settings and settings specific to the visiting user's browser. The system adapts font sizes and image dimensions to fit the resolution of the mobile screen. Finally, the feature set of the transcoded page (such as streaming video and AJAX) changes depending on capabilities of the visiting user's device and mobile network.

Regarding content selection, the selective transcoding system provides tools for selecting what content items are presented to the mobile user. The system provides a “point-and-click” tool used to select only the content most relevant in the mobile context. The content author can eliminate heavy Adobe Flash/video advertisements, unsupported content, and anything else that simply would not matter for the mobile user.

Regarding spectrum scarcity, the selective transcoding system provides a major improvement in the size of downloaded mobile web pages and the latency of accessing the pages. By using the “point-and-click” tool, the content author has the power to identify content that should not be downloaded to mobile devices. The system can reduce traffic by 90% or more for popular blogs when only the most relevant blocks (e.g., logos, articles, and copyrights) are selected. This greatly reduces load on cellular sites and response times of websites. The system proxy caches content and pages rendered for particular devices to further reduce render time and access latency.

From the foregoing, it will be appreciated that specific embodiments of the selective transcoding system have been described herein for purposes of illustration, but that various modifications may be made without deviating from the spirit and scope of the invention. Accordingly, the invention is not limited except as by the appended claims.

I/We claim:

1. A computer-implemented method for creating a mobile version of a content page, the method comprising:
receiving a selection by a content author of a content page for transcoding to a mobile version;
creating a content page template that tracks one or more selections and modifications to the received content page selection for rendering the mobile version of the content page;
identifying content items within the received content page selection;
displaying a user interface through which the content author can select one or more of the identified content items to include in the mobile version;
receiving a content item selection from the content author that indicates a content item among the identified content items for inclusion in the mobile version of the content page;
generating a mobile content item style for the content item selection that provides styling of the selected content item for a mobile device; and
storing the content page template with the generated mobile content item style in a data store,
wherein the preceding steps are performed by at least one processor.

2. The method of claim 1 wherein receiving the selection of the content page comprises receiving a uniform resource locator (URL) from the content author.

3. The method of claim 1 wherein creating a content page template comprises creating a default template that includes all of the content from an original content page scaled for one or more mobile devices.

4. The method of claim 1 wherein identifying content items comprises identifying blocks of Hypertext Markup Language (HTML) elements that the content author may want to style differently for the mobile version of the content page.

5. The method of claim 1 wherein displaying the user interface comprises providing controls for the content author to enable and disable each content item for inclusion in the mobile version of the content page.

6. The method of claim 1 wherein displaying the user interface comprises providing controls for the content author to override style information for the mobile version of the content page.

7. The method of claim 1 wherein receiving a content item selection comprises receiving from the content author a mouse click over a displayed rendering of the content item.

8. The method of claim 1 wherein generating a mobile content item style comprises removing one or more Hypertext Markup Language (HTML) tags that do not display well on the mobile device

9. The method of claim 1 wherein generating a mobile content item style comprises modifying element details to display nicely on the mobile device.

10. The method of claim 1 further comprising, after generating the mobile content item style, receiving from the content author one or more modifications to the generated mobile content item style.

11. The method of claim 1 further comprising deploying the mobile version of the content page so that users of mobile devices can access the mobile version.

12. A computer system for producing a mobile version of a content page from an existing version of the content page, the system comprising:
a processor and memory configured to execute software instructions;
a content discovery component configured to identify one or more content pages associated with a content repository;
a content template data store configured to store one or more templates for the identified content pages and any modifications made by a content author for mobile rendering of the content pages;
a content item selection component configured to display a user interface to the content author and receive one or more selections of content items associated with the identified content pages;
a content item styling component configured to generate one or more mobile styles related to one or more original styles associated with a content page; and
a deployment component configured to receive a deployment indication from the content author and deploy a mobile version of one or more content pages.

13. The system of claim 12 wherein the content discovery component is further configured to prompt a user to input a uniform resource locator (URL) of a content page that the user wants to prepare for mobile consumption.

14. The system of claim 12 wherein the content discovery component is further configured to automatically crawl a website by performing a scan of the content repository's internal structure and generating a list of potential content pages.

15. The system of claim 12 wherein the content discovery component is further configured to create a template to store changes for each discovered content page and store the template in the content template data store.

16. The system of claim 12 wherein the content item selection component is further configured to automatically identify content items by analyzing hypertext markup language (HTML) tags within the content page and to present the content items for selection by the content author.

17. The system of claim 12 wherein the content item selection component is further configured to construct one or more XPath expressions that describe positions of one or more selected content items in a document object model (DOM) structure of the content page.

18. A computer-readable storage medium comprising instructions for controlling a computer system to responds to a request for a mobile version of a content page, wherein the instructions, when executed, cause a processor to perform actions comprising:
receiving a request to access an identified content page;
determining a mobile device associated with the received request;
determining whether a mobile version of the identified content page is available for the determined mobile device;
upon determining that a mobile version of the identified content page is available for the determined mobile device,
retrieving the mobile version of the identified content page for the determined mobile device; and
responding to the received request with the retrieved mobile version of the content page.

19. The medium of claim 18 wherein determining the mobile device associated with the received request comprises examining a Hypertext Markup Language (HTML) User-Agent header provided in the request by the mobile device.

20. The medium of claim 18 wherein retrieving the mobile version comprises retrieving an original version of the content page and a modified stylesheet for rendering the content page on the determined mobile device.
